(19) United States
(12) Patent Application Publication
(10) Pub. No.: US 2006/0033349 A1
(43) Pub. Date: Feb. 16, 2006

(54) Vacuum chuck device

(76) Inventor: Dong-Hyo Shin, Seoul (KR)

Correspondence Address: SILTECH CORPORATION, 225 WICKSTEED AVENUE, TORONTO, ON, M4H1G5, CA

(21) Appl. No.: 10/495,244

(22) PCT Filed: Nov. 8, 2002
(86) PCT No.: PCT/KR02/02084

§ 371 Date: Aug. 12, 2005

(30) Foreign Application Priority Data
Nov. 8, 2001 (KR) 2001-69573

(51) Int. Cl. A47J 45/00

(52) U.S. Cl. 294/64.1

(57) ABSTRACT

Disclosed is a vacuum chuck device which detachably adheres to components by a vacuum pressure and moves up and down or rotates them with driving means such as a stepping motor in an automation process. The present invention provides a vacuum chuck device as an improved mechanism, in which a chucking member for vacuum pressure application is inserted into a spraying member for inversely spraying an introduced compressed air. Such a chucking construction can make the mechanical friction of a working part diminished and thereby the capacity of the stepping motor being a driving source reduced greatly. Accordingly, the present invention provides a miniaturized device with economical effect.

### TECHNICAL FIELD

The present invention relates to a vacuum chuck device, and more particularly, to a vacuum chuck device for adsorbing a component at an automation process and lifting or rotating the component at a certain angle, so that the component is then seceded from the vacuum chuck device.

### BACKGROUND ART

In a conventional vacuum chuck device, a vacuum pressure generated by a sucking force of a high-pressure air sprayed from a main body of the device is applied to an adsorption unit mounted at the leading edge of a tube through the overall tube, to thereby adsorb a component.

In the conventional vacuum chuck device, a vacuum pressure should be maintained in the tube. Thus, in the case that the tube is made of hard material, the structure of a moving joint should be complicated. Accordingly, a soft tube such as rubber is generally used instead of a hard tube. As a result, an adsorption unit mounted at the lower end of the tube is moved up and down or rotated, by using a flexibility of the tube.

Such a up-and-down movement or rotational operation enables an adsorption unit mounted at the lower end of the tube to operate by a rack gear or a spur gear coupled to a stepping motor. Accordingly, the tube is repeatedly twisted or bent whenever the adsorption unit is operated.

However, the following problems have occurred in the case that the soft tube has been used.

That is, in the case that a material of a tube is too excessively soft, the tube does not bear a vacuum pressure working in the tube. As a result, the middle portion of the tube strangulates and thus would not function.

Thus, the flexibility of the tube cannot but be limited. This results in a burden on a torque capacity of a stepping motor and an obstacle to making a compact device. Also, since the tube is made of a soft material, the tube is easily damaged due to a fatigue accumulated from a repetitive use. As a result, there is a problem in durability.

### DISCLOSURE OF INVENTION

To solve the above problems, it is an object of the present invention to provide a vacuum chuck device of a new mechanism which can freely perform an up-and-down movement or rotational operation of an adsorption unit without causing a mechanical frictional resistance, to thereby minimize a capacity of a stepping motor and thus make a compact vacuum chuck device.

To accomplish the above object of the present invention, there is provided a vacuum chuck device comprising a moving chuck member which is penetrated and inserted into the outer circumstance of a spray member having a reverse spray nozzle at the leading end of the vacuum chuck device, so that a space is formed together with an air discharging passage in a tubular body because of the accommodated reverse spray nozzle at which a vacuum pressure is at work in the lower portion of the vacuum chuck device.

Preferably, the moving chuck member is rotated or elevated up and down by a known driving unit.

Also, the spray member comprises a support tube having a widely opened guide piece which is annularly installed at the leading end of the support tube, and a reverse spray nozzle formed by the guide piece and a spray path incoming into the guide piece.

Also, the support tube is formed of a tubular body having a connection passage, to thereby make a space in which a vacuum pressure is at work and a vacuum pressure measuring unit communicate with each other, and measure the vacuum pressure.

### BRIEF DESCRIPTION OF DRAWINGS

The above object and other advantages of the present invention will become more apparent by describing a preferred embodiment thereof in more detail with reference to the accompanying drawings in which:

FIG. 1 is a cross-sectional view showing essential components for explaining an operational principle of the present invention; and

FIG. 2 is a detailed cross-sectional view showing the essential components of the present invention.

### BEST MODE FOR CARRYING OUT THE INVENTION

A preferred embodiment of the present invention will be described in detail with reference to the accompanying drawings.

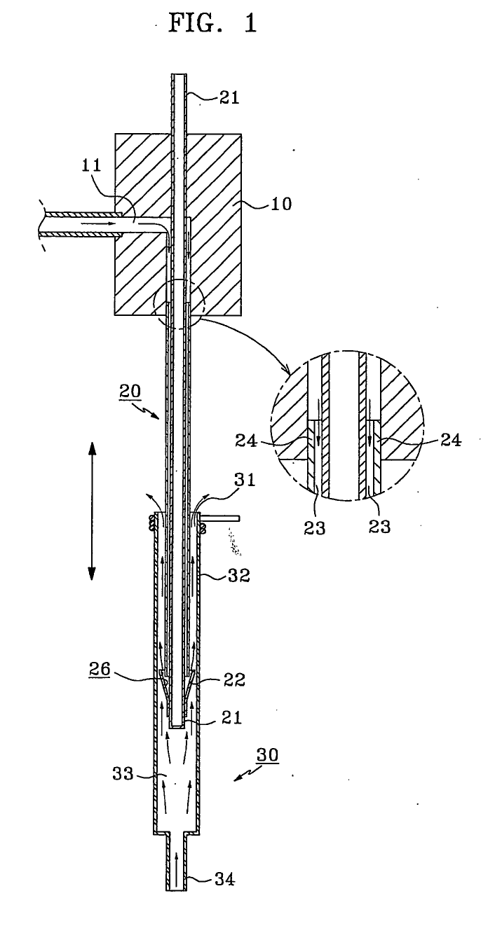

As shown in FIG. 1, a spray member 20 in a vacuum chuck device according to the present invention is fixedly formed in a fixed base 10 where a compressed air inflow passage 11 is formed.

That is, a support tube 21 and a spray tube 24 both of which form the spray member 20 are penetrated and inserted into the fixed base 10 so that a spray passage 23 is formed, in which the upper portion of the spray member 20 that is one end of the support tube 21 is embedded in the fixed base 10. A guide piece 22 which is widely opened upwards is annularly installed at the leading end of the spray member 20 that is the other end of the support tube 21. The leading end of a spray tube 24 is extended into the guide piece 22, to function as a reverse spray nozzle 26.

Meanwhile, a moving chuck member 30 in the present invention is a tubular body 32 whose upper end is open and lower end is mounted with a chuck unit 34, and is penetrated and inserted into the spray member 20 so as to slidably move by a predetermined distance to accommodate a nozzle of the spray tube 24. In this case, a widely opened portion of the guide piece 22 formed in the spray tube 24 and the inner circumferential portion of the tubular body 32 corresponding to the widely opened portion form an appropriate gap therebetween, in which the upper portion of the moving chuck member 30 functions as an air discharging passage 31 and the lower portion thereof becomes a space 33 in which a vacuum pressure works.

In the vacuum chuck device according to the present invention as described above, high-pressure compressed air passes through an inflow passage 11 in the fixed base 10 and flows into the spray passage 23 in the spray tube 24 so as to be sprayed at the leading end of the spray tube 24. Here, the sprayed compressed air flows invertedly by means of the guide piece 22 which is widely opened upwards, and thus spouts reversely strongly through a nozzle gap formed by the guide piece 22 and the leading end of the spray tube 24 so as to be discharged through the air discharging passage 31.

As described above, if the high-pressure compressed air spouts strongly through the nozzle, air filled in the space 33 is swept away and discharged together with the high-pressure compressed air. Accordingly, a vacuum pressure is produced in the space 33. As a result, a chuck unit 34 formed at the lower end of the space adsorbs a component.

As described above, if the chuck unit 34 adsorbs a predetermined component, the moving chuck member 30 is interlocked with a driving gear of a stepping motor which is separately installed as described later, and is moved up and down or rotates. In this case, the moving chuck member 30 closely contacts the spray member 20 in a non-joint form, to accordingly smoothly operate without a mechanical frictional resistance.

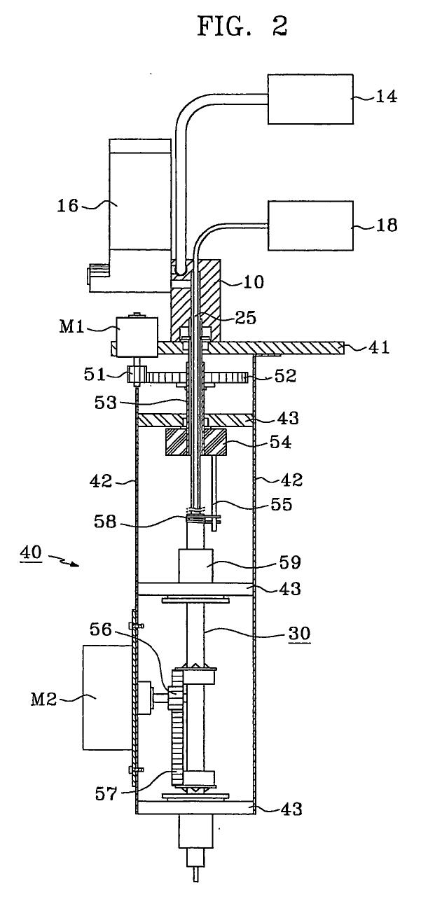

Although the support tube 21 in the spray tube 20 in FIG. 1 is clogged at the lower end thereof, and functions only as a support member, it can be realized as a support tube communicating with a connection passage 25 as shown in FIG. 2. In this case, a vacuum pressure working in the space 33 is transferred to a vacuum pressure measuring unit 18 through the connection passage 25. Accordingly, a predetermined vacuum pressure can be also measured.

Hereinbelow, a structure of lifting or rotating a component adsorbed by the chuck unit 34 will be described with reference to FIG. 2.

First, a fixed base 10 is mounted on a main flat plate frame 41. Compressed air generated from a compressed air generator 14 flows into an inflow passage 11 through a solenoid valve 16. The connection passage 25 in the support tube 21 communicates with the vacuum pressure measuring unit 18.

Vertical frames 42 are installed at both the left-hand and right-hand sides at the bottom of the main flat plate frame 41. The vertical frames are connected with three flat plate supports 43. Accordingly, the vertical frames 43 form a frame body 40 together with the main flat plate frame 41. The vacuum chuck device according to the present invention is entirely inserted in the frame body 40. Two stepping motors M1 and M2 are installed in the frame body 40. The stepping motor M1 rotates the moving chuck member 30 and the stepping motor M2 elevates the moving chuck member 30.

First, a driving gear 51 for the stepping motor Ml is tooth-engaged with a spur gear 52 installed between the main flat plate frame 41 and the upper-side flat plate support 43. Also, a rotational sleeve 53 which is inserted rotatably in the outer circumference of the spray tube 24 is integrally fixed to a disc 54 installed below the spur gear 52, together with the spur gear 52. A guide rod 55 is protruded downwards in one side of the disc 54.

Meanwhile, a driving gear 56 for the stepping motor M2 is tooth-engaged with a rack gear 57 which is vertically installed on the outer circumferencial surface of the tubular body 32 in the moving chuck member 30. A spring guide 58 is attached on the upper end of the tubular body 32 to be interlocked with the guide rod 55 of the disc 54.

Thus, if the driving gear 51 is rotated by the stepping motor M1, the spur gear 52 engaged with the driving gear 51, the rotational sleeve 53 fixed to the spur gear 52, and the disc 54 fixed to the rotational sleeve 53 are rotated in turn, and thus the guide rod 55 protruded at the lower side of the disc 54 and the spring guide 58 closely contacting the guide rod 55 are also rotated together. Finally, a component adsorbed in the chuck unit 34 which is installed in the lower end of the moving chuck member 30, is also rotated.

Next, an up-and-down elevation operation will be described. When the driving gear 56 is rotated forwardly or reversely by the stepping motor M2, the rack gear 57 tooth-engaged with the driving gear 56 is operated interlockingly. Accordingly, the moving chuck member 30 fixed to the rack gear 57 is moved up and down. Here, the maximum movement distance is set so as to be shorter than a length of the guide rod 55 of the disc 54. As a result, the spring guide 58 is not seceded from the guide rod 55. A reference numeral 59 indicates a ball bush. Also, it should be appreciated that an up-and-down moving distance and direction or a rotational angle and direction of the vacuum chuck device are controlled by a well-known automatic controller.

### INDUSTRIAL APPLICABILITY

As described above, the vacuum chuck device according to the present invention is configured to have a moving chuck member which is penetrated and inserted into a spray member having a reverse spray nozzle in a non-joint form in a condition where the nozzle is accommodated in the spray member. Accordingly, the structure of the vacuum chuck device is simple. In particular, since the moving chuck member adsorbs a component and performs an up-and-down movement or rotational movement without a mechanical frictional resistance, a required capacity of a stepping motor being a driving source can be minimized.

Thus, the present invention can provide a compact, efficient and economic vacuum chuck device. Also, the present invention has a more advantageous merit than a conventional product in its durability, since a tube is made of a hard material such as metal differently from rubber in a conventional tube.

The present invention is not limited in the above-described embodiment. It is apparent to one who is skilled in the art that there are many variations and modifications without departing off the spirit of the present invention and the scope of the appended claims.

1. A vacuum chuck device for absorbing a predetermined component under vacuum and allowing the adsorbed component to rotate or move up and down by a driving unit, the vacuum chuck device comprising a moving chuck member which is penetrated and inserted into the outer circumstance of a spray member having a reverse spray nozzle at a leading end of the vacuum chuck device, so that a space is formed together with an air discharging passage in a tubular body because of the accommodated reverse spray nozzle, in which a vacuum pressure is at work in the lower portion of the vacuum chuck device.

2. A vacuum chuck device of claim 1, wherein said spray member comprises a support tube having a widely opened guide piece which is annularly installed in the leading end of the support tube, a spray tube which is penetrated and inserted so that a spray passage is formed in the outer circumference of the support tube, and a reverse spray nozzle formed by the guide piece and the leading end of the spray tube incoming into the guide piece.

3. The vacuum chuck device of claim 2, wherein said spray tube comprises a connection passage, to make a space and a vacuum pressure measuring unit communicate with each other.
